(19) United States
(12) Patent Application Publication
(10) Pub. No.: US 2026/0062333 A1
(43) Pub. Date: Mar. 5, 2026

(54) Systems And Methods For Glass Additive Manufacturing

(71) Applicant: Product Innovation and Engineering, LLC, St. James, MO (US)

(72) Inventor: Todd E. SPARKS, Rolla, MO (US)

(21) Appl. No.: 19/283,072

(22) Filed: Jul. 28, 2025

Related U.S. Application Data
(60) Provisional application No. 63/689,335, filed on Aug. 30, 2024.

(51) Int. Cl. C03B 19/01; B33Y 30/00

(52) U.S. Cl. CPC C03B 19/01; B33Y 30/00

(57) ABSTRACT

Exemplary embodiments are disclosed of systems and methods for glass additive manufacturing. In an exemplary embodiment, a coaxial beam delivery system for an additive manufacturing system comprises an off axis parabolic (OAP) mirror with an axial through hole. The coaxial beam delivery system is configured to be operable for delivering a beam via parabolic reflection from the OAP mirror to a workpiece coaxially with feedstock being fed through the axial through hole in the OAP mirror.

### CROSS-REFERENCE TO RELATED APPLICATION

This application claims priority to and the benefit of U.S. Provisional Patent Application No. 63/689,335 filed Aug. 30, 2024. The entire disclosure of the above provisional application is incorporated herein by reference.

### FIELD

The present disclosure relates generally to systems and methods for glass additive manufacturing.

### BACKGROUND

This section provides background information related to the present disclosure which is not necessarily prior art.

Directed energy deposition (DED) is an additive manufacturing process also known as 3D printing. In DED, focused thermal energy is used to melt and fuse material as it is deposited layer by layer, building up a three-dimensional object. Unlike traditional subtractive manufacturing processes in which material is removed to create a part, additive manufacturing processes like DED add material only where it is needed.

### DRAWINGS

The drawings described herein are for illustrative purposes only of selected embodiments and not all possible implementations, and are not intended to limit the scope of the present disclosure.

FIGS. 1(a) and 1(b) illustrate two beam delivery strategies for the Off Axis Parabolic (OAP) mirror approach according to exemplary embodiments of the present disclosure. More specifically, FIG. 1(a) illustrates a galvo beam delivery method in which the galvo scanner allows for dynamic control over the position and proportion of the beam that impinges upon the feedstock. FIG. 1(b) illustrates an axicon beam delivery method in which the axicon's Bessel beam allows a free space for the feedstock to push through, while still ensconcing the material evenly at the workpiece.

FIGS. 2(a) and 2(b) respectively illustrate implementations of the galvo beam delivery method shown in FIG. 1(a) and the axicon beam delivery method shown in FIG. 1(b) according to exemplary embodiments of the present disclosure.

FIGS. 3(a) and 3(b) illustrate how the roller inclination angle with respect to the material axis (θ_{M}) determines how far (F_{R}) the round material moves per rotation of the wheel about the material axis. With reference to FIG. 3(a), angled rollers drive the glass feeder. The roller is composed of a non-marring contact material (e.g., silicone, etc.) and a hub (e.g., bronze, etc.) riding on an axle (e.g., steel, etc.). As shown in FIG. 3(b), the precision material feeder can be calibrated via trigonometry.

FIGS. 4(a), 4(b), and 4(c) show left-hand and right-hand roller arrays that can be used to feed and rotate the feedstock according to exemplary embodiments of the present disclosure. More specifically, FIG. 4(a) illustrates an exemplary array comprising multiple rollers for distributing load and keeping the feedstock centered. As shown in FIG. 4(b), each roller array traces a spiral on the feed stock material. FIG. 4(c) illustrates two roller arrays (a left-hand roller array and a right-hand roller array) for pushing the material along the material axis when the left-hand roller array counter rotates relative to the right-hand roller array.

FIGS. 5(a), 5(b), and 5(c) show three different feeder architectures that may be used in a glass additive manufacturing system according to exemplary embodiments of the present disclosure. More specifically, FIG. 5(a) illustrates an exemplary MK1 feeder that includes a single motor (e.g., a stepper motor, etc.) with bevel gears to drive both stages for feeding (e.g., pushing, etc.) the feedstock (e.g., glass rod, etc.). FIG. 5(b) illustrates an exemplary MK2 feeder that includes a pair of through-axis motors for feeding (e.g., pushing, etc.) the feedstock (e.g., glass rod, etc.). FIG. 5(c) illustrates an exemplary MK3 feeder for feeding the feedstock (e.g., glass rod, etc.). The MK3 feeder includes a pair of belt driven stages to reduce dimension of the feeder along the feed axis.

FIG. 6(a) illustrates a heated build surface assembly that may be used in a glass additive manufacturing system according to exemplary embodiments of the present disclosure. The stainless steel foil build surface assembly allows the glass to stick or adhere to the stainless steel foil when the stainless steel foil is hot (e.g., resistively heated, etc.). But the glass will not stick or adhere to the stainless steel foil when the stainless steel foil is cool. As shown in FIG. 6(a), the resistively heated stainless steel foil is pulled taught over a backer plate (e.g., ceramic backer, etc.) to thereby forms the build surface in the glass additive manufacturing system.

FIG. 6(b) shows a prototype of a stainless steel foil build surface according to exemplary embodiments of the present disclosure. The prototype stainless steel build surface was tested without a backer plate (e.g., ceramic backer plate, etc.). For this prototype, the stainless steel was resistively heated to approximately 650° C.

FIG. 7 shows a prototype ceramic backer plate that may be used in a heated build surface assembly for a glass additive manufacturing system according to exemplary embodiments of the present disclosure. The ceramic backer plate may be provided by forming in clay and firing. The porosity of the bisque firing may contribute to the temperature resistance of the resulting ceramic backer plate. FIG. 7 shows the ceramic backer plate after many hours of use in a glass additive manufacturing system as disclosed herein. Also shown in FIG. 7 is a small divot melted into the ceramic backer plate after receiving a direct shot from the CO₂ laser, which resulting thermal shock would have destroyed other backer plates made from other materials.

FIG. 8 shows a beam shape incident on the workpiece while beam realigning for a prototype system according to exemplary embodiments of the present disclosure. In FIG. 8, the dark sheet has marks from several test fires of the CO₂ laser after making some adjustments to the mirror. The small gap in the ring is the shadow of the tube carrying the glass feedstock. The larger the input beam is, the less energy waste with the tube interaction. The red laser is for positional reference and does not show the accurate path of the CO₂ laser's beam due to wavelength dependent indices of refraction of the optics in the path.

### DETAILED DESCRIPTION

Example embodiments will now be described more fully with reference to the accompanying drawings.

Exemplary embodiments were developed and/or are disclosed herein of systems and methods based on and/or configured to be operable via a directed energy deposition approach using a carbon dioxide (CO₂) laser. In exemplary embodiments, the systems and methods disclosed herein may advantageously enable and/or be used for 3D printing of engineering grade optical elements (e.g., lenses, etc.). But aspects of the present disclosure are not limited only the 3D printing of engineering grade optical elements as exemplary embodiments of the systems and methods disclosed herein may be used for 3D printing other items or objects besides lenses and engineering grade optical elements.

During the development process, enabling technologies were created relating to (1) beam delivery, (2) precision material feed, and (3) heated build surface.

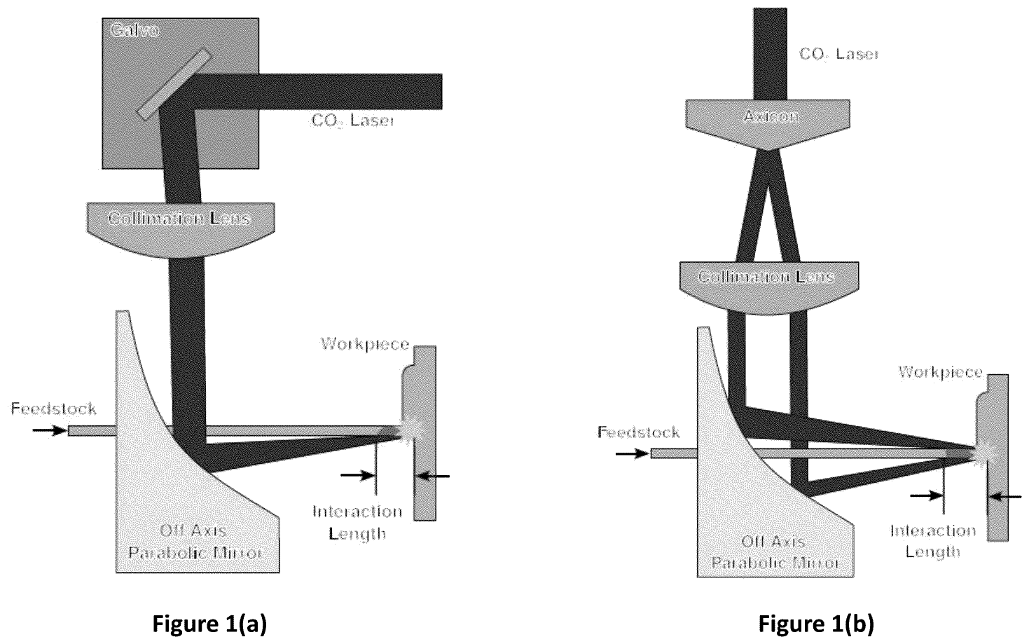

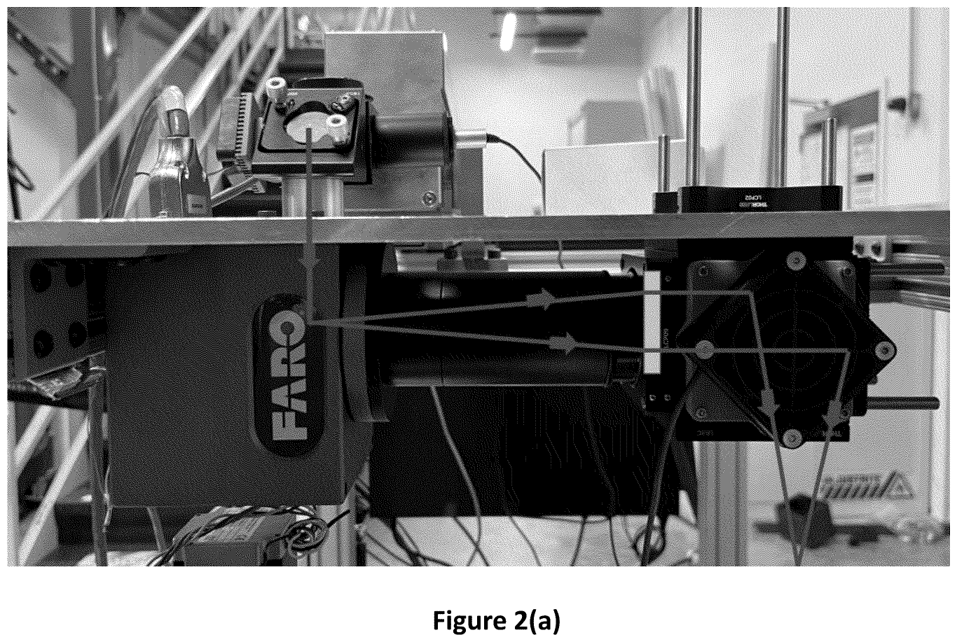

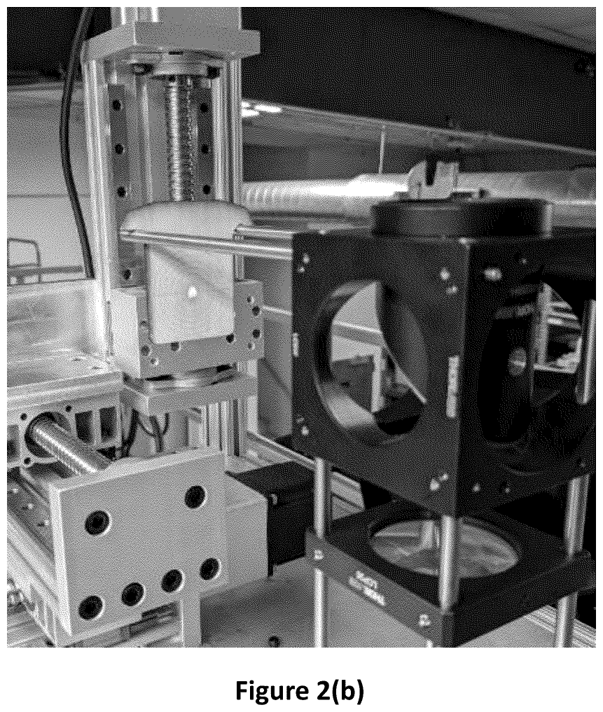

Beam Delivery—An off axis parabolic (OAP) mirror with an axial through hole was configured to be operable for delivering a CO₂ laser beam (via parabolic reflective optics) to the workpiece coaxially with the feedstock that is fed through the axial through hole in the OAP mirror. This arrangement allows for controlled balance of laser exposure of the feedstock and the workpiece, thereby allowing for complete material melting while minimizing vaporization of glass. Two exemplary configurations of coaxial beam delivery for additive manufacturing via parabolic reflective optics were developed and are described below with reference to FIGS. 1(a), 1(b), 2(a), and 2(b).

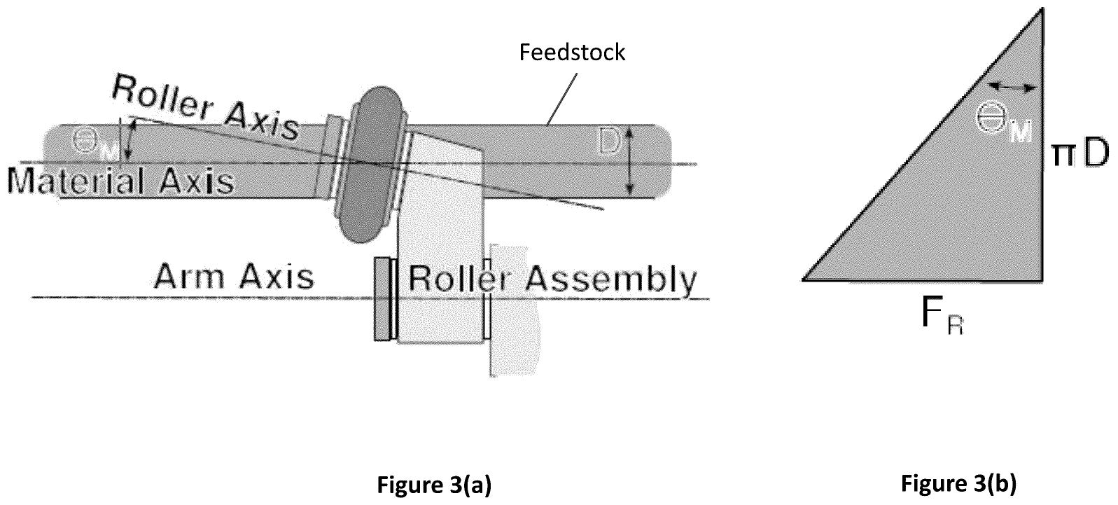

Precision Material Feed—As recognized herein, conventional wire feeders for welding or filament feeders for fused deposition modeling (FDM) 3D printing deform the feedstock in order to apply enough force to the material to ensure no slipping. But for glass filaments or rods, this would fracture the feedstock inside the printer. As further recognized herein, the axial force requirement for glass printing can be higher than a wire based metal process because the viscosity of the glass melt is comparatively high. After recognizing the above, exemplary feeders were developed and are described below with reference to FIGS. 3(a), 3(b), 4(a), 4(b), 4(c), 5(a), 5(b), and 5(c). As disclosed below, exemplary feeders are configured to use inverted threadless lead screw concepts where multiple points of contact are used to drive the glass rod without slipping according to exemplary embodiments of the present disclosure.

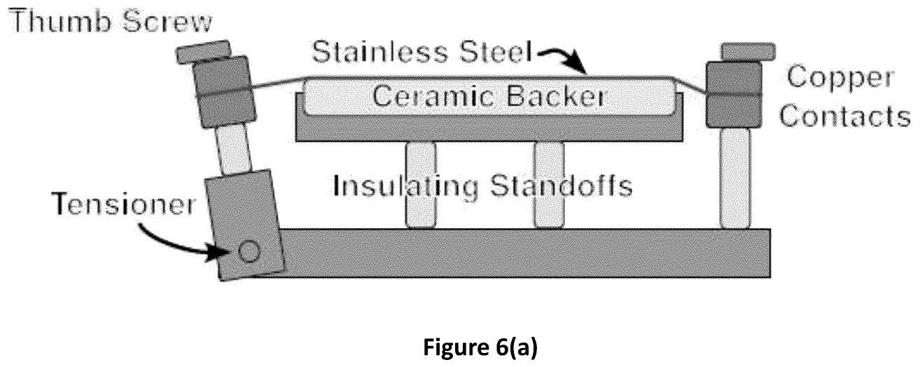

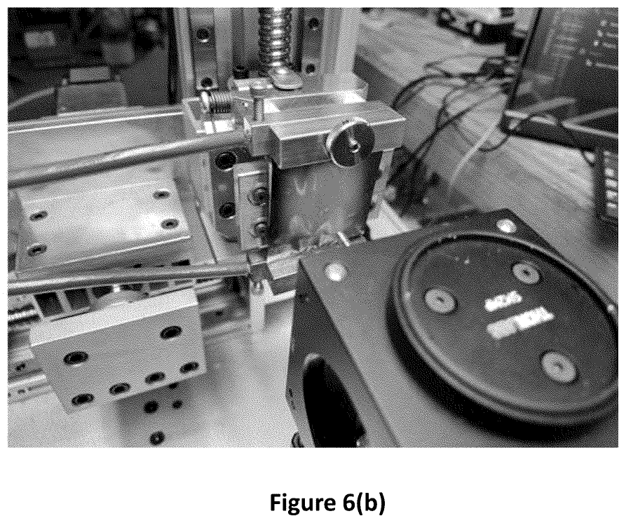

Heated Build Surface—A resistive heater element was used to heat a glass substrate material upon which the print process would occur. The low thermal conductivity of glass meant that thin substrate materials were better for thermal reasons, but thick substrates were required to resist the resulting residual stresses. And if a print were ultimately successful, the print would need to be removed from the substrate material via grinding or a diamond saw. After recognizing the above shortcomings, exemplary embodiments of glass additive manufacturing systems were developed and/or disclosed herein that were configured to be operable for directly printing on resistively heated stainless steel foil build surfaces, which are described below with reference to FIGS. 6(a) and 6(b).

### Coaxial Beam Delivery for Additive Manufacturing Via Parabolic Reflective Optics

An innovative beam delivery system was developed for additive manufacturing. In exemplary embodiments, the beam delivery system was developed with the following objectives recognized by the inventor hereof: (1) evenly heat the glass feedstock to avoid thermal fractures, (2) reduce or eliminate glass vaporization, and (3) bond the feedstock material to the workpiece.

These objectives were advantageously achieved through the use of an off axis parabolic (OAP) mirror. In exemplary embodiments disclosed herein, an innovative beam delivery system is configured to be operable for producing a hollow circular beam incident on the OAP mirror's surface perpendicular to the focal axis that interacts with the glass material fed through the axial through hole in the OAP mirror. The innovative coaxial beam delivery was achieved via two different methods—a galvo method shown in FIG. 1(a) and an axicon method shown in FIG. 1(b).

In the galvo beam delivery methods shown in FIG. 1(a), the galvo scanner allows for dynamic control over the position and proportion of the beam that impinges upon the feedstock. The galvo method approximates the axicon method but the galvo method is dynamically controllable at the cost of additional complexity. FIG. 2(a) illustrates an exemplary implementation of the galvo beam delivery method shown in FIG. 1(a).

As shown in FIG. 1(a), a CO₂ laser beam is deflected by a galvo scanner. From the galvo scanner, the deflected CO₂ laser beam passes through a collimation lens before striking the off axis parabolic (OAP) mirror. The CO₂ laser beam is reflected by the OAP mirror such that the CO₂ laser beam is delivered to the workpiece coaxially with the feedstock (e.g., glass rod, etc.), which is being fed through an axial through hole in the OAP mirror. Advantageously, this arrangement shown in FIG. 1(a) allows for controlled balance of laser exposure of the feedstock and the workpiece, thereby allowing for complete material melting while minimizing vaporization of glass.

In the axicon beam delivery method shown in FIG. 1(b), the axicon's Bessel beam allows a free space for the feedstock to push through, while still ensconcing the material evenly at the workpiece. FIG. 2(b) illustrates an exemplary implementation of the axicon beam delivery method shown in FIG. 1(b).

As shown in FIG. 1(b), a CO₂ laser beam passes through the axicon. From the axicon, the CO₂ laser beam (e.g., the now ring shaped CO₂ laser beam, etc.) passes through a collimation lens before striking the off axis parabolic (OAP) mirror. The CO₂ laser beam is reflected by the OAP mirror such that the CO₂ laser beam is delivered to the workpiece coaxially with the feedstock (e.g., glass rod, etc.), which is being fed through an axial through hole in the OAP mirror. Advantageously, this arrangement shown in FIG. 1(b) allows for controlled balance of laser exposure of the feedstock and the workpiece, thereby allowing for complete material melting while minimizing vaporization of glass.

One of the key features of both coaxial beam delivery methods shown in FIGS. 1(a) and 1(b) is the designed interaction length, which is how the system distributes power along the feedstock and into the workpiece. The diameter of the circular CO₂ laser beam incident on the OAP mirror's surface sets the angle of the cone with a point at the foci of the OAP mirror. This interaction length is controlled either dynamically by the galvo shown in FIG. 1(a) or statically by the axicon and collimation lens choice shown in FIG. 1(b).

The “thickness” of the circle of the circular CO₂ laser beam determines how much of the solid angle of the cone is empty. This is determined by the input beam size into either the galvo (FIG. 1(a)) or the axicon (FIG. 1(b)), which can be set by a beam expander stage (not shown in FIGS. 1(a) and 1(b)) ahead of the delivery optics. The diameter and thickness parameters together set the interaction length as shown in both FIGS. 1(a) and 1(b).

### Precision Material Feeder for Wire, Tube, or Round Bar

As recognized herein, glass additive manufacturing suffers from a chicken-or- egg problem in that there is no material ecosystem because there was no commercial process. Not only was there no material but there also was no feed system. Glass fiber is a tempting option but there is very little mono-material glass fiber produced.

As further recognized herein, existing feed systems for round materials include fused deposition modeling/fused filament fabrication (FDM/FFF) style filament extrusion systems and wire feed systems from conventional welding processes. Both of these feeder styles “bite” into the feedstock in order to grip the feedstock. But “biting” into the feedstock for grip will shatter glass feedstock. A simple pinch wheel is functional with glass feedstock but simple pinch wheels only have a single contact point, which makes it difficult to push the glass hard enough to overcome the viscosity of the melted glass. During the inventive process, it was discovered that the viscosity of melted glass is much higher than the melted metals used during additive manufacturing.

After recognizing the above, exemplary feed systems and methods were developed and/or are disclosed herein for feeding round glass rods without shattering or fracturing the round glass rods. Disclosed herein are exemplary feed systems that include and/or are based on a threadless lead screw mechanism in which a smooth rod is rotated to move a “nut” comprised of several angled wheels. The exemplary feed systems disclosed herein may also be used for feeding other feedstock besides round glass rods, including wires, tubular materials, round bars, feedstock made from other materials besides glass, etc. Accordingly, the exemplary feed systems disclosed herein should not be limited to use with only glass rod feedstock.

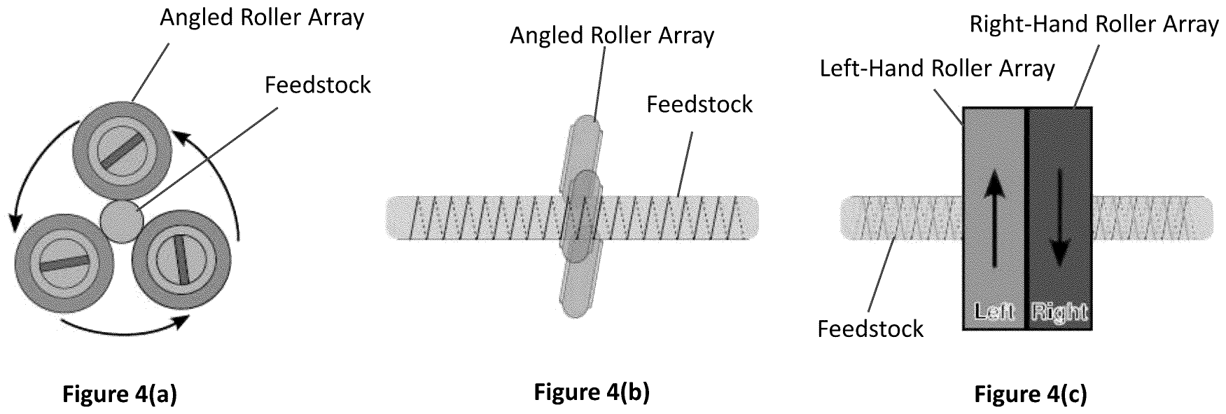

With reference to FIGS. 3(a), 3(b), 4(a), 4(b), and 4(c), the exemplary feeder construction can be characterized by the angular difference between the material feed axis and the roller axis:

$$tan ( {Δθ}_{M} ) = \frac{{F}_{R}}{π D}$$

In the above equation, θ_{M} is the roller angle, D is the feedstock diameter, and F_{R} is the linear feed per revolution. Thus, for a glass rod having a 2 millimeter (mm) diameter and a 10° roller axis angle, the glass rod is fed 1.1 mm per roller array revolution. If a direct drive stepper motor configuration is used with a typical 200 steps per revolution motor, the feed precision is a staggering 5.5 micrometers (μm) per full motor step. Resolution this high allows for very precise, smooth feedstock motions with even modest control hardware.

With reference to FIG. 3(a), angled rollers drive the feedstock in exemplary embodiments. The rollers comprise a non-marring contact material (e.g., silicone, etc.) and a hub (e.g., bronze, etc.) riding on an axle (e.g., steel, etc.). As shown in FIG. 3(b), the precision material feeder can be calibrated via trigonometry.

FIGS. 4(a), 4(b), and 4(c) show left-hand and right-hand roller arrays that can be used to feed and rotate the feedstock according to exemplary embodiments of the present disclosure. More specifically, FIG. 4(a) illustrates an exemplary array comprising multiple rollers (e.g., three angled rollers, etc.) for distributing load and keeping the feedstock centered. As shown in FIG. 4(b), each roller array traces a spiral on the feedstock material. FIG. 4(c) illustrates a left-hand roller array and a right-hand roller array for pushing the material along the material axis when the left-hand roller array and the right-hand roller array are counter rotated relative to each other.

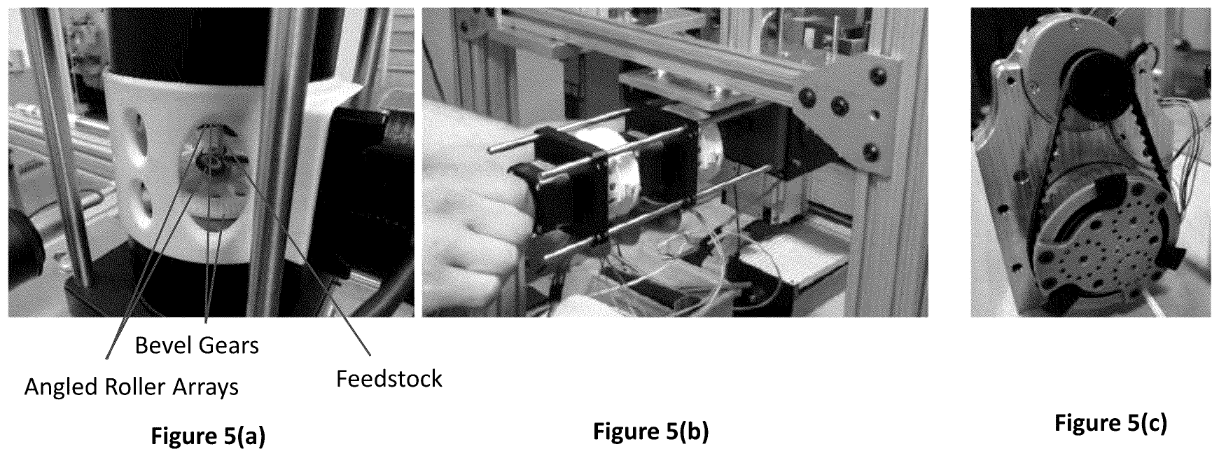

FIGS. 5(a), 5(b), and 5(c) show three different feeder architectures that may be used in a glass additive manufacturing system according to exemplary embodiments of the present disclosure. More specifically, FIG. 5(a) illustrates an exemplary MK1 feeder that includes a single motor (e.g., a stepper motor, etc.) with first and second bevel gears to drive both stages (first and second angled roller arrays) for feeding (e.g., pushing, etc.) the feedstock (e.g., glass rod, etc.). As shown in FIG. 5(a), the exemplary MK1 feeder includes first and second angled roller arrays. Each of the first and second angled roller arrays may include three angled rollers for feeding the feedstock along a feed axis (e.g., centerline axis, etc.) between the three angled rollers of each roller array.

FIG. 5(b) illustrates an exemplary MK2 feeder that includes first and second through axis motors to respectively drive first and second angled roller arrays for feeding (e.g., pushing, etc.) the feedstock (e.g., glass rod, etc.). The first through axis motor is operable for driving a first angled roller array. The second through axis motor is operable for driving a second angled roller array. Each of the first and second angled roller arrays may include three angled rollers for feeding the feedstock along a feed axis (e.g., centerline axis, etc.) between the three angled rollers of each roller array.

FIG. 5(c) illustrates an exemplary MK3 feeder for feeding the feedstock (e.g., glass rod, etc.) that includes a pair of belt driven stages to reduce dimension of the feeder along the feed axis. The first belt driven stage is operable for driving a first angled roller array. The second belt driven stage is operable for driving a second angled roller array. Each of the first and second angled roller arrays may include three angled rollers for feeding the feedstock along a feed axis (e.g., centerline axis, etc.) between the three angled rollers of each roller array.

### Build Surface for 3D Printed Glass Materials

Also disclosed herein are heated build surfaces that can function as a complete analog for a polyethyleneimine (PEI) coated build plate in a conventional fused deposition modeling (FDM) process. During a glass additive manufacturing process, glass will advantageously stick or adhere to the heated build surface when hot, but the glass will release from the heated build surface when the build surface is cool.

FIG. 6(a) illustrates a stainless steel foil build surface assembly that may be used in a glass additive manufacturing system according to exemplary embodiments of the present disclosure. The stainless steel foil build surface allows the glass to stick or adhere to the stainless steel foil when the stainless steel foil is hot (e.g., resistively heated, etc.). But the glass will not stick or adhere to the stainless steel foil when the stainless steel foil is cool. As shown in FIG. 6(a), the resistively heated stainless steel foil is pulled taut over a backer plate (e.g., ceramic backer, etc.) to thereby form the build surface for a glass additive manufacturing system.

FIG. 6(b) shows a prototype of a stainless steel foil build surface, which was tested without a backer plate (e.g., ceramic backer plate, etc.). For this prototype, the stainless steel was resistively heated to approximately 650° C.

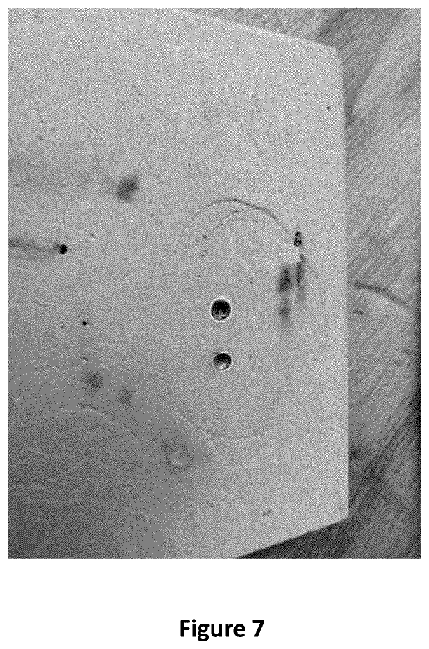

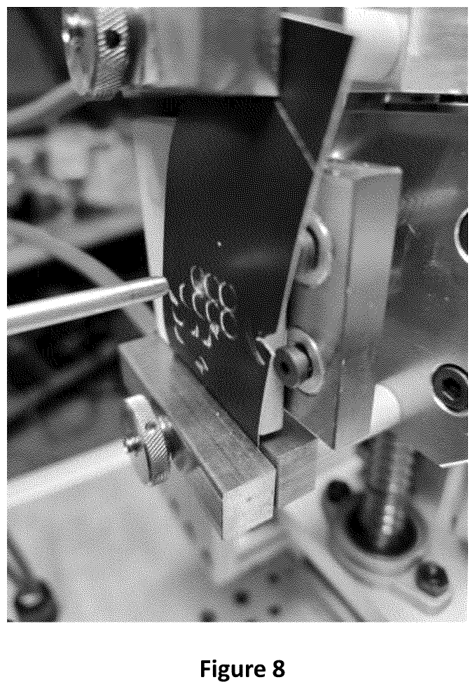

FIG. 7 shows a prototype ceramic backer plate that may be used in a heated build surface assembly for a glass additive manufacturing system according to exemplary embodiments of the present disclosure. The ceramic backer plate may be provided by forming in clay and firing. The porosity of the bisque firing may contribute to the temperature resistance of the resulting ceramic backer plate. FIG. 7 shows the ceramic backer plate after many hours of use in a glass additive manufacturing system as disclosed herein. Also shown in FIG. 7 is a small divot melted into the ceramic backer plate after receiving a direct shot from the CO₂ laser, which resulting thermal shock would have destroyed other backer plates made from other materials.

In exemplary embodiments, the build plate solution includes a 0.001 inch thick passivated stainless steel foil resistively heated with a 3.3 volt, 60 amp power supply. The glass will adhere to the hot surface of the resistively heated passivated stainless steel foil. When the process is complete and the heater is turned off, the mismatch in the coefficients of thermal expansion (CTE) of the glass and the stainless steel foil will cause the printed glass object to shear off the foil surface. Some oxides may remain with the glass material, which would require polishing but this is still less onerous than grinding or cutting a large substrate material.

Exemplary embodiments are disclosed of coaxial beam delivery systems for additive manufacturing systems. In exemplary embodiments, the coaxial beam delivery system comprises an off axis parabolic (OAP) mirror with an axial through hole. The coaxial beam delivery system is configured to be operable for delivering a beam via parabolic reflection from the OAP mirror to a workpiece coaxially with feedstock being fed through the axial through hole in the OAP mirror.

In exemplary embodiments, the coaxial beam delivery system is configured to be operable for evenly heating glass feedstock to help avoid thermal fractures, reduce or eliminate glass vaporization, and bond the glass feedstock material to the workpiece.

In exemplary embodiments, the coaxial beam delivery system is configured to be operable for producing a hollow circular beam incident on the OAP mirror's surface perpendicular to a focal axis that interacts with the feedstock that is fed through the axial through hole in the OAP mirror.

In exemplary embodiments, the coaxial beam delivery system includes a galvo scanner configured to allow for dynamic control over position and proportion of the beam that impinges upon the feedstock.

In exemplary embodiments, the coaxial beam delivery system includes a galvo scanner and a collimation lens. The galvo scanner is configured to deflect the beam to the collimation lens. The collimation lens is configured such that the deflected beam passes through the collimation lens and is reflected by the OAP mirror to the workpiece coaxially with the feedstock being fed through the axial through hole in the OAP mirror.

In exemplary embodiments, the coaxial beam delivery system includes an axicon configured such that the axicon's Bessel beam allows a free space for the feedstock to push through, while still ensconcing the feedstock material evenly at the workpiece.

In exemplary embodiments, the coaxial beam delivery system includes an axicon and a collimation lens configured such that the beam passes through the axicon, passes through the collimation lens, and is reflected by the OAP mirror to the workpiece coaxially with the feedstock being fed through the axial through hole in the OAP mirror.

In exemplary embodiments, the coaxial beam delivery system is configured to have an interaction length that determines how the coaxial beam delivery system distributes power along the feedstock and into the workpiece. The diameter of the circular beam incident on the OAP mirror's surface sets the angle of the cone with a point at the foci of the OAP mirror. The interaction length is controllable either dynamically by a galvo or statically by an axicon and collimation lens choice. And a thickness of the circle of the circular beam determines how much of the solid angle of the cone is empty, which is determined by input beam size into either the galvo or the axicon, and the diameter and thickness parameters together set the interaction length.

In exemplary embodiments, the coaxial beam delivery system is configured to allow for controlled balance of laser exposure of the feedstock and the workpiece, thereby allowing for complete glass melting while minimizing vaporization of the feedstock.

In exemplary embodiments. the coaxial beam delivery system is configured to be operable for delivering a CO₂ laser beam via parabolic reflection from the OAP mirror to the workpiece coaxially with the feedstock being fed through the axial through hole in the OAP mirror.

Also disclosed are exemplary embodiments of material feeders for feeding feedstock to build surfaces of additive manufacturing systems. In exemplary embodiments, the material feeder comprises one or more arrays of multiple angled rollers configured to contact the feedstock along multiple sides of the feedstock. The multiple angled rollers are operable for rotating and pushing the feedstock along a longitudinal axis of the feedstock towards the build surface of the additive manufacturing system when the multiple angled rollers of the one or more arrays are being rotated.

In exemplary embodiments, the one or more arrays of multiple angled rollers comprise a first array of multiple angled rollers and a second array of multiple angled rollers that is spaced apart from the first array of multiple angled rollers. The multiple angled rollers of the second array are counter-rotatable relative to the multiple angled rollers of the first array. The first and second arrays of multiple angled rollers are operable for rotating and pushing the feedstock along the longitudinal axis of the feedstock towards the build surface when the multiple angled rollers of the first array are counter-rotated relative to the multiple angled rollers of the second array.

In exemplary embodiments, the material feeder includes a single motor with first and second bevel gears to drive the multiple angled rollers of the respective first and second arrays for feeding the feedstock towards the build surface. In other exemplary embodiments, the material feeder includes first and second through axis motors to drive the multiple angled rollers of the respective first and second arrays for feeding the feedstock towards the build surface. In further exemplary embodiments, the material feeder is configured to use first and second belt driven stages to drive the multiple angled rollers of the respective first and second arrays for feeding the feedstock towards the build surface.

In exemplary embodiments, the multiple angled rollers of the one or more arrays are configured to a spiral along the feedstock material as the multiple angled rollers are being rotated to thereby rotate and push the feedstock along the longitudinal axis of the feedstock towards the build surface.

In exemplary embodiments, each of the one or more arrays of multiple angled rollers comprises three angled rollers.

In exemplary embodiments, each of the one or more arrays of multiple angled rollers is configured to have a roller angle of about 10° between the axis of each angled roller and the longitudinal axis of the feedstock.

In exemplary embodiments, the material feeder is configured to be operable for rotating and pushing a round glass rod feedstock along a longitudinal centerline axis of the round glass rod feedstock towards the build surface without shattering or fracturing the round glass rod feedstock when the multiple angled rollers of the one or more arrays are being rotated.

In exemplary embodiments, the material feeder is configured to be operable for rotating and pushing wire, tubular, and/or round bar feedstock along a longitudinal axis of the wire, tubular, and/or round bar feedstock towards the build surface when the multiple angled rollers of the one or more arrays are being rotated.

In exemplary embodiments, the one or more arrays of multiple angled rollers are configured to be operable for distributing load along the multiple sides of the feedstock and maintaining the feedstock centered when the multiple angled rollers of the one or more arrays are being rotated for feeding the feedstock towards the build surface.

In exemplary embodiments, the material feeder includes a direct drive stepper motor configuration with a 200 steps per revolution motor. And the material feeder is operable with a feed precision of about 5.5 micrometers (μm) per full motor step for a round glass rod having a diameter of about 2 millimeters, a roller axis angle of about a 10°, and a linear feed per revolution of about 1.1 mm.

Also disclosed are exemplary embodiments of heated build surface assemblies for glass additive manufacturing systems. In exemplary embodiments, the heated build surface assembly includes a build surface and a heater thermally coupled with the build surface for heating the build surface. The heated build surface assembly is configured such that glass printed on the build surface via the glass additive manufacturing system sticks or adheres to the build surface when the build surface is being heated by the heater and releases from the build surface when the build surface cools and is no longer being heated by the heater.

In exemplary embodiments, the build surface comprises a material having a first coefficient of thermal expansion that is different than a second coefficient of thermal expansion of the printed glass. The mismatch in the first and second coefficients of thermal expansion of the respective build surface and printed glass will cause the printed glass to shear off the build surface when the heater is turned off.

In exemplary embodiments, the heater comprises a resistive heater element configured to heat the build surface upon which the glass will be printed via the glass additive manufacturing system.

In exemplary embodiments, the build surface comprises passivated stainless steel.

In exemplary embodiments, the build surface comprises stainless steel foil.

In exemplary embodiments, a ceramic backer plate is disposed under the build surface.

In exemplary embodiments, the build surface comprises about a 0.001 inch thick passivated stainless steel foil that is resistively heated with a 3.3 volt, 60 amp power supply.

Exemplary embodiments of additive manufacturing systems are also disclosed herein. In exemplary embodiments, an additive manufacturing system (e.g., a glass additive manufacturing system, etc.) comprises one or more of: a coaxial beam delivery system as disclosed herein; and/or a material feeder as disclosed herein; and/or a heated build surface assembly as disclosed herein.

Exemplary methods relating to additive manufacturing are disclosed herein. For example, disclosed herein are exemplary methods of delivering a beam to a workpiece coaxially with feedstock. Also disclosed herein are exemplary methods for feeding feedstock to a build surface of an additive manufacturing system. Disclosed herein are also method of using a heated build surface assembly during an additive manufacturing process.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A coaxial beam delivery system for an additive manufacturing system, the coaxial beam delivery system comprising an off axis parabolic (OAP) mirror with an axial through hole, the coaxial beam delivery system is configured to be operable for delivering a beam via parabolic reflection from the OAP mirror to a workpiece coaxially with feedstock being fed through the axial through hole in the OAP mirror.

2. The coaxial beam delivery system of claim 1, wherein the coaxial beam delivery system is configured to be operable for evenly heating glass feedstock to help avoid thermal fractures, reduce or eliminate glass vaporization, and bond the glass feedstock to the workpiece.

3. The coaxial beam delivery system of claim 1, wherein the coaxial beam delivery system is configured to be operable for producing a hollow circular beam incident on the OAP mirror's surface perpendicular to a focal axis that interacts with the feedstock that is fed through the axial through hole in the OAP mirror.

4. The coaxial beam delivery system of claim 1, wherein the coaxial beam delivery system includes a galvo scanner configured to allow for dynamic control over position and proportion of the beam that impinges upon the feedstock.

5. The coaxial beam delivery system of claim 1, wherein:
the coaxial beam delivery system includes a galvo scanner and a collimation lens;
the galvo scanner is configured to deflect the beam to the collimation lens; and
the collimation lens is configured such that the beam deflected by the galvo scanner passes through the collimation lens and is reflected by the OAP mirror to the workpiece coaxially with the feedstock being fed through the axial through hole in the OAP mirror.

6. The coaxial beam delivery system of claim 1, wherein the coaxial beam delivery system includes an axicon configured to create a Bessel beam that allows a free space for the feedstock to push through, while still ensconcing feedstock material evenly at the workpiece.

7. The coaxial beam delivery system of claim 1, wherein the coaxial beam delivery system includes an axicon and a collimation lens configured such that the beam passes through the axicon, passes through the collimation lens, and is reflected by the OAP mirror to the workpiece coaxially with the feedstock being fed through the axial through hole in the OAP mirror.

8. The coaxial beam delivery system of claim 1, wherein:
the coaxial beam delivery system is configured to have an interaction length that determines how the coaxial beam delivery system distributes power along the feedstock and into the workpiece;
a diameter of a circular beam incident on the OAP mirror's surface sets an angle of the cone with a point at the foci of the OAP mirror;
the interaction length is controllable either dynamically by a galvo or statically by an axicon and collimation lens choice; and
a thickness of the circle of the circular beam determines how much of the angle of the cone is empty, which is determined by input beam size into either the galvo or the axicon, and the diameter and thickness parameters together set the interaction length.

9. The coaxial beam delivery system of claim 1, wherein the coaxial beam delivery system is configured to allow for controlled balance of laser exposure of the feedstock and the workpiece, thereby allowing for complete glass melting while minimizing vaporization of the feedstock.

10. The coaxial beam delivery system of claim 1, wherein the coaxial beam delivery system is configured to be operable for delivering a CO₂ laser beam via parabolic reflection from the OAP mirror to the workpiece coaxially with the feedstock being fed through the axial through hole in the OAP mirror.

11. An additive manufacturing system comprising the coaxial beam delivery system of claim 1 and a build surface, wherein the additive manufacturing system further comprises:
a material feeder for feeding feedstock to the build surface, the material feeder comprising one or more arrays of multiple angled rollers configured to contact the feedstock along multiple sides of the feedstock, whereby the multiple angled rollers are operable for rotating and pushing the feedstock along a longitudinal axis of the feedstock towards the build surface of the additive manufacturing system when the multiple angled rollers of the one or more arrays are being rotated; and/or
a heated build surface assembly including the build surface and a heater thermally coupled with the build surface for heating the build surface, whereby the heated build surface assembly is configured such that glass printed on the build surface via the additive manufacturing system sticks or adheres to the build surface when the build surface is being heated by the heater and releases from the build surface when the build surface cools and is no longer being heated by the heater.

12. A material feeder for feeding feedstock to a build surface of an additive manufacturing system, the material feeder comprising one or more arrays of multiple angled rollers configured to contact the feedstock along multiple sides of the feedstock, whereby the multiple angled rollers are operable for rotating and pushing the feedstock along a longitudinal axis of the feedstock towards the build surface of the additive manufacturing system when the multiple angled rollers of the one or more arrays are being rotated.

13. The material feeder of claim 12, wherein:
the one or more arrays of multiple angled rollers comprise:
a first array of multiple angled rollers; and
a second array of multiple angled rollers that is spaced apart from the first array of multiple angled rollers, the multiple angled rollers of the second array are counter-rotatable relative to the multiple angled rollers of the first array of multiple angled rollers;
whereby the first and second arrays of multiple angled rollers are operable for rotating and pushing the feedstock along the longitudinal axis of the feedstock towards the build surface when the multiple angled rollers of the first array are counter-rotated relative to the multiple angled rollers of the second array.

14. The material feeder of claim 12, wherein the material feeder includes a single motor with first and second bevel gears to drive the multiple angled rollers of the respective first and second arrays for feeding the feedstock towards the build surface.

15. The material feeder of claim 12, wherein the material feeder includes first and second through axis motors to drive the multiple angled rollers of the respective first and second arrays for feeding the feedstock towards the build surface.

16. The material feeder of claim 12, wherein the material feeder is configured to use first and second belt driven stages to drive the multiple angled rollers of the respective first and second arrays for feeding the feedstock towards the build surface.

17. The material feeder of claim 12, wherein the multiple angled rollers of the one or more arrays are configured to a spiral along the feedstock as the multiple angled rollers are being rotated to thereby rotate and push the feedstock along the longitudinal axis of the feedstock towards the build surface.

18. The material feeder of claim 12, wherein each said one or more arrays of multiple angled rollers comprises three angled rollers.

19. The material feeder of claim 12, wherein each said one or more arrays of multiple angled rollers is configured to have a roller angle of about 10° between the axis of each angled roller and the longitudinal axis of the feedstock.

20. The material feeder of claim 12, wherein the material feeder is configured to be operable for rotating and pushing a round glass rod feedstock along a longitudinal centerline axis of the round glass rod feedstock towards the build surface without shattering or fracturing the round glass rod feedstock when the multiple angled rollers of the one or more arrays are being rotated.

21. The material feeder of claim 12, wherein the material feeder is configured to be operable for rotating and pushing wire, tubular, and/or round bar feedstock along a longitudinal axis of the wire, tubular, and/or round bar feedstock towards the build surface when the multiple angled rollers of the one or more arrays are being rotated.

22. The material feeder of claim 12, wherein the one or more arrays of multiple angled rollers are configured to be operable for distributing load along the multiple sides of the feedstock and maintaining the feedstock centered when the multiple angled rollers of the one or more arrays are being rotated for feeding the feedstock towards the build surface.

23. The material feeder of claim 12, wherein the material feeder includes a direct drive stepper motor configuration with a 200 steps per revolution motor, whereby the material feeder is operable with a feed precision of about 5.5 micrometers (um) per full motor step for a round glass rod having a diameter of about 2 millimeters, a roller axis angle of about a 10°, and a linear feed per revolution of about 1.1 mm.

24. A heated build surface assembly for a glass additive manufacturing system, the heated build surface assembly comprises a build surface and a heater thermally coupled with the build surface for heating the build surface, whereby the heated build surface assembly is configured such that glass printed on the build surface via the glass additive manufacturing system sticks or adheres to the build surface when the build surface is being heated by the heater and releases from the build surface when the build surface cools and is no longer being heated by the heater.

25. The heated build surface assembly of claim 24, wherein the build surface comprises a material having a first coefficient of thermal expansion that is different than a second coefficient of thermal expansion of the printed glass, whereby the mismatch in the first and second coefficients of thermal expansion of the respective build surface and printed glass will cause the printed glass to shear off the build surface when the heater is turned off.

26. The heated build surface assembly of claim 24, wherein the heater comprises a resistive heater element configured to heat the build surface upon which glass will be printed via the glass additive manufacturing system.

27. The heated build surface assembly of claim 24, wherein:
the build surface comprises passivated stainless steel; and/or
the build surface comprises stainless steel foil; and/or
a ceramic backer plate is disposed under the build surface; and/or
the build surface comprises about a 0.001 inch thick passivated stainless steel foil that is resistively heated with a 3.3 volt, 60 amp power supply.
